(19) United States
(12) Patent Application Publication
(10) Pub. No.: US 2006/0163307 A1
(43) Pub. Date: Jul. 27, 2006

(54) Note paper dispenser incorporating a roll of calculator paper

(76) Inventor: Gary Hartman Kilgore, San Antonio, TX (US)

Correspondence Address: Gary Kilgore, 239 Calumet Place, San Antonio, TX, 78209, US

(21) Appl. No.: 11/041,665

(22) Filed: Jan. 21, 2005

(51) Int. Cl. B26F 3/02

(52) U.S. Cl. 225/51; 225/66

(57) ABSTRACT

A note paper dispenser incorporating a roll of calculator paper includes: a means to attach a roll of calculator paper to said dispenser; a table; a course leading from a location of an installed roll of calculator paper to said table; and a severing means. The attachment means restricts free movement of the roll of calculator paper to rotation about its' axis. By hand manipulation, paper is fed off its' roll through the course to the table, and from there to the severing means.

### BACKGROUND OF INVENTION

1. Field of Invention

The novelty disclosed in this document pertains to a note paper dispenser. More narrowly, to a fixture configured to house a roll of calculator paper on which notes or lists can be inscribed. From hovels to extravagant abodes, from the dingy pockets of itinerate wanderers to the most imposing aircraft and vessels, you find every imaginable system for recording instructions, thoughts, needs, and tasks. All sorts of fixtures, pads, binders, calendars, journals, computer programs, and assorted electronic devices to facilitate note writing have been devised by mankind to compensate for the disparity between our ability to conjure ideas and our inability to corral them. For humans that are organized, or at least fancy themselves so, a physical place for making notations is essential.

2. Prior Art

A dispenser for note paper is a rudimentary fixture. So much so, that I found little prior art in the patent record. In 1989, Windorski was issued U.S. Pat. No. 4,848,584 on a dispenser for sheets of adhesive backed note paper, which was assigned to 3M. It is markedly dissimilar to this present application, and has no relevance to the novelty claimed here. In 1991, Windorski was granted a design patent, No. D316,112 for another dispenser for adhesive backed note paper. Again, it is dissimilar to the present application, and has no relevance to the novelty claimed here. U.S. Pat. No. 5,904,283 was issued to Kanbar in 1999, and is relevant. Kanbar describes a dispenser for note paper from a roll. However, he claims a motor driven belt juxtaposed to a roll of adhesive backed paper. The device described by Kanbar shares no components with the present application. U.S. Pat. No. 3,507,428 was issued to Liebreich in 1970, and assigned to Mead Corporation. This is a electrically operated device for cutting lengths of material from a roll. The claims are relatively broad, however, this device shares no components with the present application. In 1933, Perrin was issued U.S. Pat. No. 1,913,722 for a paper towel dispenser. In form and function Perrin's device is dissimilar to the present application. U.S. Pat. No. 393,627 was issued to Ehrlich in 1888 for a paper cutter. Ehrlich's device supports a roll of paper and provides a knife for cutting lengths from the roll. While Ehrlich's paper cutter is dissimilar to the present application in form and function, the fundamental elements are similar: a fixture for a roll of paper; and a means to cut lengths of paper from a roll. Foreseeing an office action citing this patent, my claims are narrowed to a device that incorporates a roll of calculator paper.

### BRIEF SUMMARY OF THE INVENTION

The improvement disclosed in this document is a fixture for dispensing and facilitating inscription of note paper. It is configured to house and dispense from a roll of calculator paper. A spindle and/or a housing secures a roll of calculator paper to the dispenser. Paper plays off of the roll through a course and over a table, then to a severing edge by hand manipulation. Paper installed in the fixture is fed from its' roll through a course which leads to a table, where notations may be made. Paper is removed from the fixture by feeding the paper further through the course to a severing edge. Paper is manually severed from the fixture.

### BRIEF DESCRIPTION OF THE SEVERAL VIEWS OF THE DRAWINGS

FIG. 1—A first side 10 provides unhindered access to attachment means 1 located within the containment means 5, and to course 3 for loading a roll of calculator paper by hand manipulation. A table 2 and severing means 4 are viewed from a side.

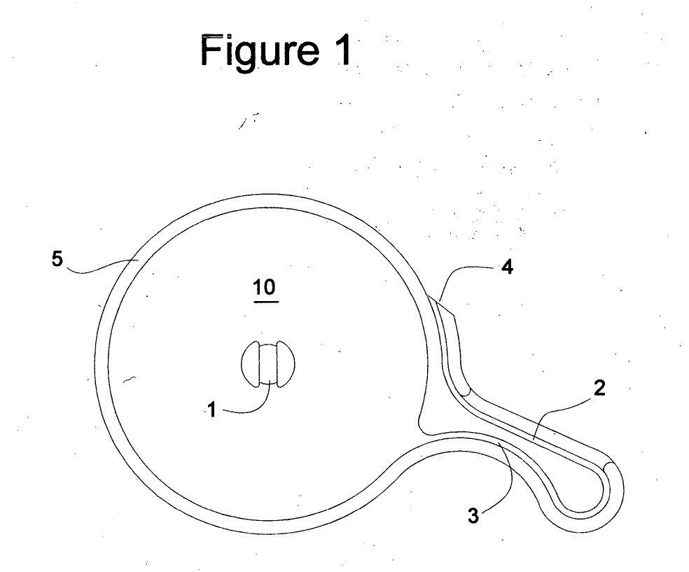

FIG. 2—A second side 20 illustrates an embodiment of the containment means 5.

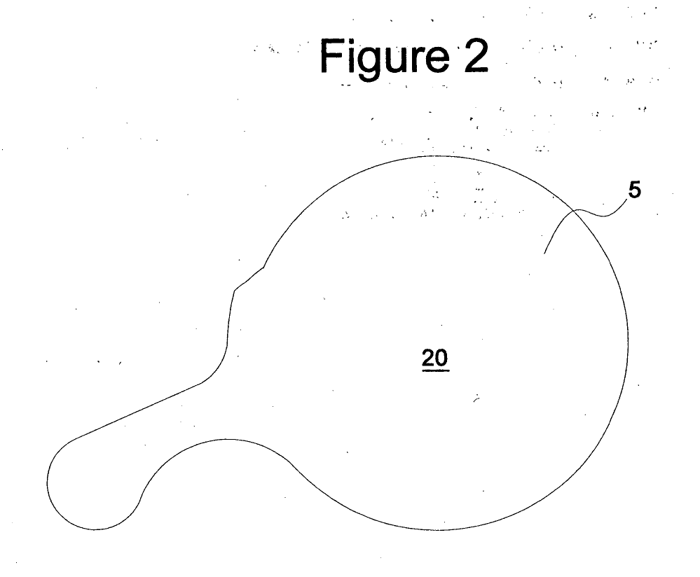

FIG. 3—A view of a third side 30 illustrates the table 2, the severing means 4, and the containment means 5.

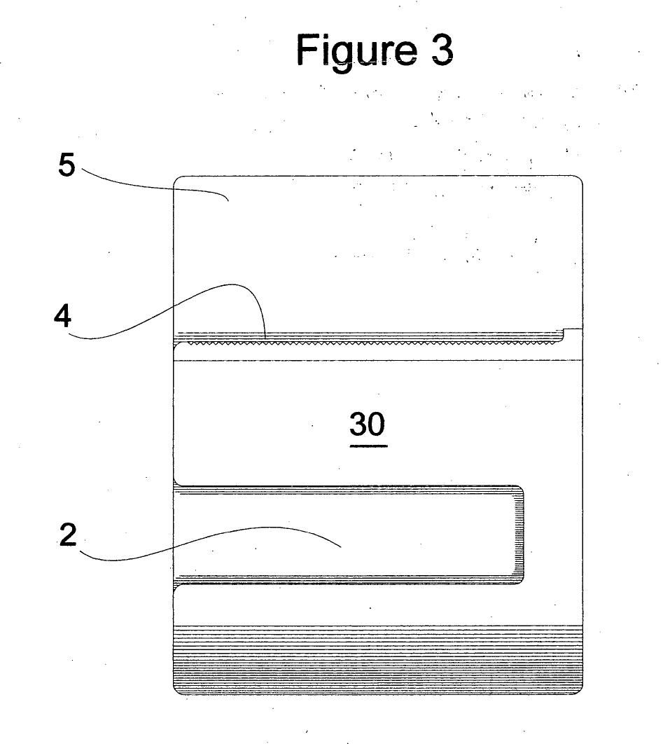

### REFERENCE NUMERALS IN DRAWINGS

1—attachment means; means to attach

2—table

3—course

4—severing means

5—containment means; means to contain

10—a first side of fixture

20—a second side of fixture

30—a third side of fixture

### DETAILED DESCRIPTION OF THE INVENTION

A note paper dispenser incorporating a roll of calculator paper as illustrated according to the invention is shown to have a means to attach 1 and/or a means to contain 5 a roll of calculator paper; a table 2; a course 3; and a severing means 4. The attachment means 1 and/or containment means 5 limits movement of a roll of calculator paper to rotation about its' axis. The course 3 provides a conduit for paper played off the paper roll to the table 2, which provides a suitable supporting surface for paper so that a user may make notations on the paper. The course 3 continues beyond the table 2 and terminates at the severing means 4. Paper is manually fed through the course 3 and removed from the fixture at the severing means 4 by hand manipulation.

A note paper dispenser incorporating a roll of calculator paper has been described in some detail by way of illustrations for purposes of clarity and understanding. It will, of course, be understood that various changes and modifications may be made in the form, details, and arrangements of the parts without departing from the scope of the invention as set forth in the claims.

I claim:

1. A note paper dispenser incorporating a roll of calculator paper.

2. A note paper dispenser incorporating a roll of calculator paper, comprising: a means to attach a roll of calculator paper to said dispenser and restrict movement of said roll of paper to rotation about the axis of its' core; a table; a course leading from a location of said roll of paper to said table; a fixed severing means.

3. A note paper dispenser incorporating a roll of calculator paper, comprising: a means to contain a roll of calculator paper in said dispenser and restrict movement of said roll of paper to rotation about the axis of its' core; a table; a course leading from a location of said roll of paper to said table; a fixed severing means.
